(19) United States
(12) Patent Application Publication
(10) Pub. No.: US 2005/0060411 A1
(43) Pub. Date: Mar. 17, 2005

(54) System and method for adaptation of peer-to-peer multimedia sessions

(76) Inventors: Stephane Coulombe, Irving, TX (US); Umesh Chandra, Allen, TX (US)

Correspondence Address: Crawford Maunu PLLC;Suite 390, 1270 Northland Drive, St. Paul, MN, 55120, US

(21) Appl. No.: 10/664,058

(22) Filed: Sep. 16, 2003

(51) Int. Cl. G06F 15/16

(52) U.S. Cl. 709/227

(57) ABSTRACT

A system and method is provided that allows proxy servers to receive capability and preference information concerning user agents (502 and 510) desiring to establish a media session. The proxy server compares the capabilities of the user agents and determines whether an incompatibility exists between them. In the event that an incompatibility does exist, the proxy server may invoke the services of an adaptation server (508) to provide the necessary adaptation required to allow the media session to proceed. The adaptation system allows either the terminating or originating proxy server to make the adaptation determination to allow the adaptation server to modify the offered media session descriptions so that the media streams may be routed through the adaptation server to adapt between incompatible media parameters.

### FIELD OF THE INVENTION

This invention relates in general to peer-to-peer multimedia sessions and the adaptation of the sessions and media streams to enable interoperability, and more particularly, to multimedia sessions using Session Initiation Protocol (SIP) in the Third Generation Partnership Project (3GPP) Internet Protocol Multimedia Subsystem (IMS) architecture.

### BACKGROUND OF THE INVENTION

The explosion of the communications industry has facilitated a blurring of the business boundaries between carriers of different networks including fixed networks, mobile networks, and the Internet. New business paradigms, in which the different networks and their associated capabilities may interoperate, will be necessary if carriers are to succeed in the 3G mobile industry. An All-IP communication system may facilitate the new business paradigms by allowing the integration of the various network capabilities into a single IP layer.

IP allows all communication services to be carried over a single network infrastructure, enabling the integration of voice, data, and multimedia services. The All-IP network will offer carriers a number of important benefits, to include cost savings, scalability, flexibility, efficient network operations, and new revenue opportunities. As such, carriers will be able to offer new and better ways to develop and offer applications and services to their subscribers.

An All-IP communication system is optimized to support multimedia services, where the adoption of SIP is a key ingredient in providing this new functionality. The IETF-standardized SIP, the 3GPP IP Multimedia Subsystem (IMS), and the IP Multimedia Domain (IP-MM Domain) system as specified by the Third Generation Partnership Project 2 (3GPP2), provide a common signaling protocol and a system architecture that join the web and mobile domains by providing integrated multimedia capabilities for IP enabled devices such as multimedia messaging, voice, and data.

Although IP is the protocol to be used for packet routing in the All-IP communication system, IP traffic is far from being homogenous. Different types of traffic routed by IP create a variety of specialized requirements for the network. Real-time voice services, for example, set strict end-to-end delay requirements for packet transport. Data processing and media access over the radio network is time-consuming, thus the delay budget for the packet network is tighter in the mobile domain than in the Web domain. In addition, basic multimedia streaming services must enable interoperability between devices and services, such that mobile streaming services may interoperate between different devices and carriers.

Prior to the transition to an All-IP network, radio access technology will evolve to allow streaming over packet switched General Packet Radio Service (GPRS) and Wideband Code Division Multiple Access (WCDMA) bearers to mobile devices. The need for adaptation will arise because of the requirement to meet interoperability in a dynamic market where mobile terminals have a wide variety of media and network capabilities. The device capability differences may be due to differing terminal categories, e.g., basic or premium, or they may be due to generation disparities caused by continuous technology advances.

For example, two users having differing device capability may want to set up a video session, whereby the first user requires H.263 video format while the second user requires the Motion Pictures Experts Group MPEG-4 video format. Without a video transcoder placed between the two users, the video session will not be possible, since a common Coder/Decoder (codec) will not be identified for use between the two users.

Prior art attempts to bridge the gap between incompatible devices, requires the end points to first determine that an intermediary is needed to perform the video transcoding service. Secondly, the end points are required to invoke the services of the intermediary so that video transcoding may be performed between the H.263 and MPEG-4 devices. This solution, however, requires new call flow protocols that are not compatible with present call flows established in 3GPP.

Accordingly, there is a need in the communications industry for a system and method that facilitates invocation of a transcoding intermediary without the need to create new call protocols that are inconsistent with established 3GPP architecture. Further, a need exists to invoke data stream transcoding services that are performed by the intermediary by allowing changes to the media type, codec, and other parameters of the media session definitions.

### SUMMARY OF THE INVENTION

To overcome limitations in the prior art, and to overcome other limitations that will become apparent upon reading and understanding the present specification, the present invention discloses a system and method for enabling interoperability between terminals having different media types, codecs, or attributes which otherwise would not have the ability to communicate. The present invention requires no modification to existing mobile terminals, thus mobile terminals having differing media capabilities are nevertheless capable of establishing a multimedia session between one another. In addition, the existing call flow as specified by the 3GPP IMS is used, thus obviating the need for establishing new call flows.

In accordance with one embodiment of the invention, a method for establishing a media session between terminals having incompatible media characteristics is provided. The method comprises transmitting a first media session description associated with a first terminal to a network element, comparing the first media session description to a second media session description associated with a second terminal, determining an incompatibility between the first and second media session descriptions, and invoking an adaptation server by the network element to adapt media flow between the first and second terminals. The adaptation server alters the first media session description to meet capabilities of the second terminal and alters the second media session description to meet capabilities of the first terminal.

In accordance with another embodiment of the invention, an adaptation system for peer-to-peer multimedia sessions is provided. The adaptation system comprises a network proxy coupled to receive media session definitions indicative of first and second terminal capabilities, and an adaptation server coupled to receive the media session definitions from the network proxy and coupled to provide adaptation of media streams and associated media session definitions between the first and second terminals. The media streams are redirected to the adaptation server in response to an incompatibility discovery between the capabilities of the first and second terminals.

In accordance with another embodiment of the invention, a proxy within a network used to facilitate an adaptation decision is provided. The proxy comprises means for receiving a capability description associated with a first terminal, means for receiving a capability description associated with a second terminal, means for comparing the capability descriptions of the first and second terminals, means for determining an incompatibility between the first and second terminals, means for transmitting the capability descriptions to an adaptation server for alteration by the adaptation server, and means for redirecting media streams to the adaptation server to adapt the media streams in response to the incompatibility between the first and second terminals.

In accordance with another embodiment of the invention, a computer-readable medium having instructions stored thereon which are executable by a proxy for facilitating media stream adaptation is provided. The instructions perform steps comprising receiving a capability description associated with a first terminal, receiving a capability description associated with a second terminal, comparing the capability descriptions of the first and second terminals to determine an incompatibility between them, transmitting the capability descriptions to an adaptation server for modification, and redirecting the media stream to the adaptation server in response to the modified capability descriptions.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates an exemplary communication system architecture in accordance with the present invention;

FIG. 2 illustrates an exemplary SIP network according to the principles of the present invention;

FIG. 3 illustrates an exemplary message flow diagram in accordance with the present invention;

FIG. 4 illustrates an exemplary media session diagram in accordance with the present invention;

FIG. 5 illustrates an exemplary adaptation process in accordance with the present invention;

FIG. 6 illustrates an alternate message flow diagram in accordance with the present invention; and

FIG. 7 is a representative computing system capable of carrying out proxy server functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a method and system that provides a framework for adaptation, whereby a network element determines the need for adaptation based upon capabilities of the end terminals. The capabilities may be expressed in a Session Description Protocol (SDP) description, in the originating parties' preferences, or by any other means related to video/audio/messaging session capabilities. Thus, there are no changes required in the end terminals to facilitate the media session. Rather, adaptation is performed transparently to the end terminals by the intervening network elements.

A session initiated by SIP generally utilizes a combination of media content such as speech, audio and video streams, but the session may also contain shared applications such as whiteboard or text messages. Even network gaming sessions may be setup by SIP as long as all of the participating applications understand the required parameters for the game. SIP is especially advantageous when a variety of protocols and mechanisms are required in support of a particular session. In particular, Voice over IP (VoIP) requires session setup signaling between two User Agents (UA); a transport such as Real-time Transport Protocol (RTP) to carry the actual voice payload; and control such as the RTP Control Protocol (RTCP) to monitor the quality of the service and to generate reports to the network, all of which may be successfully handled in a SIP message exchange.

SIP is an emerging Internet Engineering Task Force (IETF) standard for setting up multimedia sessions within, for example, an All-IP network. SIP's basic capabilities are setup, modification, and teardown of any communications session and is, therefore, considered to be a true signaling protocol. SIP also provides personal mobility, meaning that a consumer is reachable via a single address regardless of his current point of attachment to the network. SIP is suitable for combined services because it borrows many features from the HyperText Transfer Protocol (HTTP) and the Simple Mail Transfer Protocol (SMTP), which are currently widely used on the Internet for Web browsing and e-mail, respectively. SIP is designed to be the call state control protocol to be used for call setup and teardown signaling within the 3G All-IP system architecture.

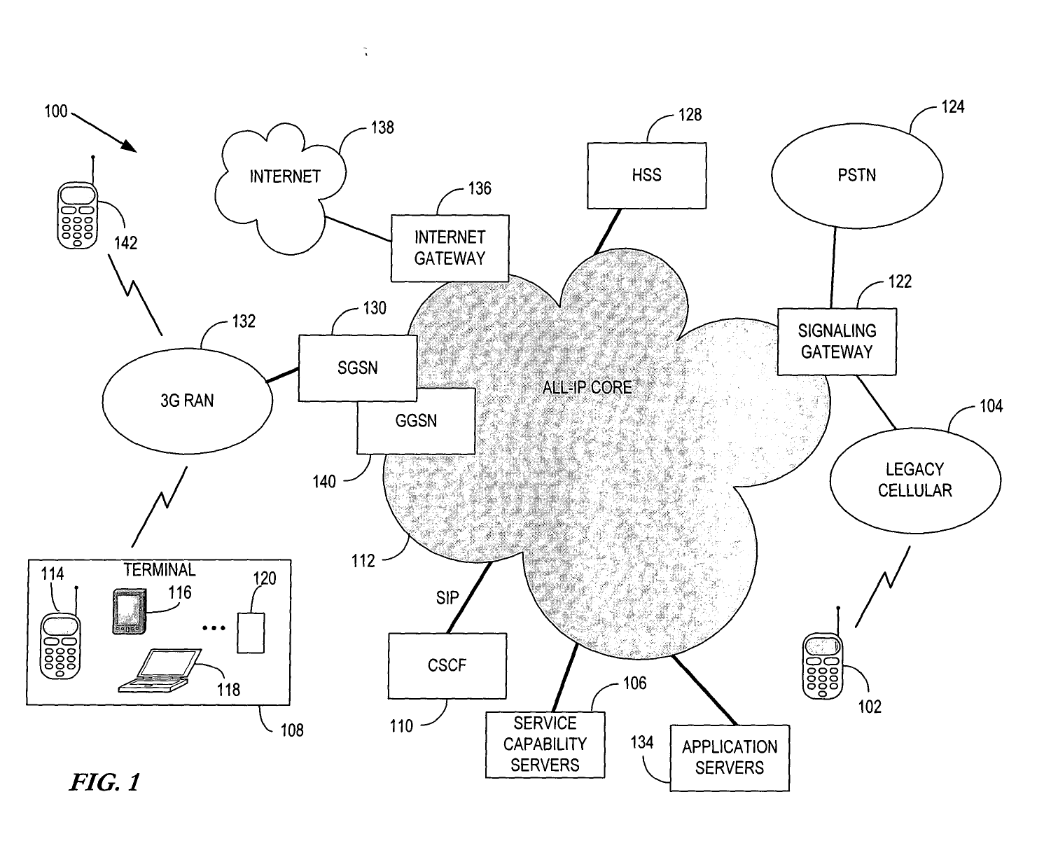

Exemplary communication system 100 illustrated in FIG. 1, may be used in accordance with the present invention. All-IP core 112 provides the common, IP based signaling core utilized by system 100 to integrate various fixed, mobile, and Internet networks. All-IP core 112 allows all communication services to be carried over a single network infrastructure, thus enabling the integration of voice, data, and multimedia services. Further, All-IP core 112 allows network resources to be used more efficiently, where increased capacity may be deployed as necessary to meet demand.

Communication system 100 is optimized to support multimedia services, where Call State Control Function (CSCF) 110 implementing SIP is a key ingredient in providing the multimedia services to all IP enabled devices. Although SIP's primary objective was meant for multimedia sessions, its scope may be extended to presence, gaming, and Instant Messaging (IM), to name only a few. Numerous applications can be implemented using SIP, allowing the combination of traditional telephony with messaging and multimedia. For example, SIP can enhance the concept of caller identification from one of simply displaying the number of the calling party to terminal 108, for example, to one of rich content identification. The calling party may, for example, display his personalized logo or business card information to terminal 108 and deliver the subject of the pending call in text, video, or picture format, depending upon the capabilities of terminal 108.

The wireless terminal 108 may represent any of a number of mobile communication devices, such as a cellular telephone 114, a personal digital assistant (PDA) 116, a notebook or laptop computer 118, or any other type of wireless terminal represented by device 120. 3G Radio Access Network (RAN) 132 represents a combination of all mobile radio standards, such as Global System for Mobile Communications (GSM)/Enhanced Data Rates for Global Evolution (EDGE), Wideband Code Division Multiple Access (WCDMA), and Wireless Local Area Network (WLAN). Each mobile radio standard has its own distinct network architectures and transport mechanisms that are fully integrated using the IP protocol, where Serving General Packet Radio Service (GPRS) Support Node (SGSN) 130 and Gateway GPRS Support Node (GGSN) 140 provides the RAN interface to All-IP core 112. It should be noted, that the present invention is not limited to wireless terminal applications, but may also apply, for example, to non-wireless terminals such as PCs interconnected via wireless or wired IP networks.

Communication system 100 also supports Legacy Cellular systems 104 that offers communication support to non All-IP terminal 102, for example. Signaling gateway 122 performs all necessary Signaling System No. 7 (SS7) and Mobile Application Part (MAP) signaling conversions as necessary to provide SS7 over IP access from PSTN 124 and MAP over IP access from Legacy Cellular system 104 to All-IP core 112. In addition, signaling gateway 122 provides Short Message Service Center (SMSC) support and Multimedia Message Service Center (MMSC) support for any SMS and MMS operations as required by mobile terminal 102.

Internet 138 access from All-IP core 112 is provided through internet gateway 136 to allow accesses defined by Uniform Resource Locator (URL) and Uniform Resource Identifier (URI) address definitions. Home Subscriber Server (HSS) 128 provides All-IP core 112 with the many database functions that are required in All-IP networks. HSS 128, for example, includes Home Location Register (HLR), Domain Name Server (DNS), network access, and security data bases.

Service capability servers 106 and application servers 134 provide consumer applications and services that are not easily provided within the circuit switched or packet core networks by themselves. For example, a transcoding intermediary may be provided by service capability servers 106 to support transcoding services between, for example, H.263/MPEG-4 video stream transcoding from one of mobile terminals 108 to mobile terminal 142. Other service groups having major relevance in 3G All-IP networks include information and entertainment content providers, communication, productivity enhancing services and business solutions. Accordingly, services that are timely, personalized, simple to complete, and location specific are provided to all consumers of communication system 100.

SIP enabled call control within communication system 100 is provided by CSCF 110, where SIP is hierarchically located in the session layer of the Open System Integration (OSI) model of protocol stack communication. SIP enabled devices may engage in direct communication to send, for example, multimedia messages between them. According to 3GPP Rel5 or Rel6 specifications, however, if the SDP detects an incompatibility between, for example, the codecs used by the SIP enabled devices, then a common codec will not be identified and the session will not take place. In one embodiment according to the principles of the present invention, an intermediary is established that allows two terminals to set up multimedia sessions between them, despite having incompatible terminal capabilities.

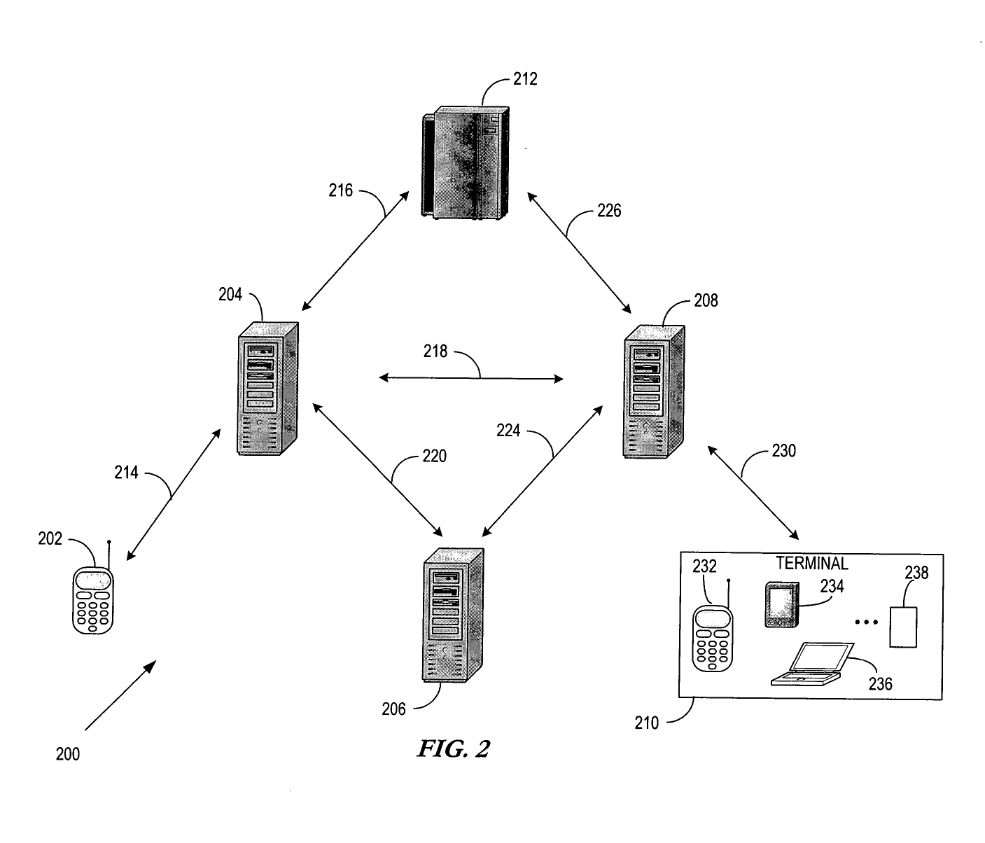

FIG. 2 illustrates exemplary SIP network 200 according to the principles of the present invention that provides intermediary support for multimedia sessions between mobile terminals having incompatible capabilities. Elements of SIP enabled network 200 may include, for example, user agents, e.g. mobile terminal 202 and mobile terminal 210, SIP servers 204 and 208, profile server 206, and adaptation server 212. Mobile terminal 210 may be comprised of any one of a mobile phone 232, PDA 234, laptop computer 236, or other mobile device 238. User agents are the end devices in a SIP network and they originate SIP requests to establish media sessions to send and receive media. A user agent may also be a gateway to another network, such as signaling gateway 122 of FIG. 1. Each user agent comprises a user agent client that initiates requests and a user agent server that generates the responses to the requests. Adaptation server 212 is arranged to communicate to SIP servers 204 and 208, via paths 216 and 226, in the event adaptations services are required to adapt the content transferred between user agents 202 and 210 during their multimedia session.

SIP servers 204 and 208 are servers that assist user agents in session establishment and other functions. SIP servers may represent a SIP proxy that receives SIP requests from a user agent, via paths 214 or 230, or another proxy, via path 218, and forwards the request to another location. SIP servers may also represent a redirect server that receives a request from a user agent or proxy and returns a redirection response indicating where the request should be retried. SIP servers may also represent a registrar server that receives SIP registration requests and updates the user agent's information into a profile server, e.g., 206, or other database, via paths 220 or 224. SIP servers 204 and 208 may also represent network elements identified in the 3GPP architecture such as a Serving Call State Control Function (S-CSCF) as represented, for example, by CSCF 110 of FIG. 1.

SIP servers 204 and 208 may be located by any number of different methods executed by their respective user agents. User agents 202 and 210, for example, may be configured with IP addresses of a primary and a secondary SIP proxy server in much the same way that a web browser contains a default web page that it loads upon initialization.

Initial session establishment in SIP network 200 must determine a negotiated set of media characteristics including a common codec or set of common codecs for multimedia session(s) that will be used for the session. This is done through an end-to-end message exchange to determine the complete set of media characteristics required during the multimedia session. The end-to-end message exchanges are intercepted by SIP proxies 204 and 208 and a decision is made by the SIP proxies as to whether adaptation will be required to support the media session. Alternatively, the decision as to whether adaptation will be required may be performed by the adaptation server. In either case, the adaptation function performed is determined by the adaptation server based upon the media capabilities of the end points. Alternatively, the adaptation server may have the capability to provide several acceptable format adaptations, where the final decision as to which format to be used during the multimedia session is determined by the end points themselves.

In an exemplary embodiment according to the present invention, a session initiator includes an SDP description in the SIP INVITE message listing every media characteristic, including codecs, that it is willing to support for a particular multimedia session. When the message arrives at the SIP proxy, the SIP proxy parses the SDP description received in the INVITE message and modifies the SDP description to meet the capability description of the session terminator that was received, for example, in a prior registration session.

One purpose of the SDP description is to convey information about media streams in multimedia sessions to allow the recipients of a session description to participate in the session. The SDP description includes for example: the type of media, e.g., audio, video; the transport protocol, e.g., RTP/UDP/IP, H.320, etc.; and the format of the media, e.g., H.263 video, MPEG-4 video, etc. For an IP multicast session, the multicast address for media and the transport port for media are conveyed, whereas for an IP unicast session, a remote address for media and a transport port for contact address are conveyed.

SDP session descriptions are entirely textual and consist of textual lines in the form of <type>=<value>. <type> is always one character and is case-significant. <value> is a structured text string whose format depends on <type>. The various SDP session type descriptions are listed in Table 1. Session descriptors 1-12 pertain to the session description, session descriptors 13-14 pertain to the time description, and

TABLE 1

| SDP DESCRIPTORS | TYPE | VALUE DESCRIPTION |
|---|---|---|
| 1 | v | Protocol version |
| 2 | o | Owner/creator and session identifier |
| 3 | s | Session name |
| 4 | i | Session information |
| 5 | u | URI of description |
| 6 | e | email address |
| 7 | p | Phone number |
| 8 | c | Connection information |
| 9 | b | Bandwidth information |
| 10 | z | Time zone adjustments |
| 11 | k | Encryption key |
| 12 | a | Attribute lines |
| 13 | t | Time session is active |
| 14 | r | Repeat times |
| 15 | m | Media name and transport address |
| 16 | i | Media title |
| 17 | c | Connection information |
| 18 | b | Bandwidth Information |
| 19 | k | Encryption key |
| 20 | a | Media attribute lines |

session descriptors 15-20 pertain to the media description.

In another exemplary embodiment according to the present invention, device capabilities of the user agents may first be accessed from registrar or profile server 206 by SIP proxies 204 and 208 via paths 220 and 224, respectively. Based upon the device capabilities of the user agents as reported by their respective registrar or profile servers, SIP proxies 204 and 208 determine the need for adaptation. In an alternate embodiment according to the present invention, user agents may communicate their capabilities during a default SDP session during registration, or alternatively in response to an OPTIONS request from a proxy server.

In an alternate embodiment according to the present invention, user agents may communicate their device capabilities using the User Agent Profile (UAProf) specification, also referred to as Capability and Preference Information (CPI), between a Wireless Access Protocol (WAP) client, the intermediate network points, and the origin server. The specification uses the Composite Capability/Preference Profile (CC/PP) model to define a robust, extensible framework for describing and transmitting CPI about the client, user, and network that will be processing content contained in a Wireless Session Protocol (WSP) response.

The UAProf specification defines a set of components and attributes that WAP-enabled components may convey within the CPI. The CPI may include, for example: hardware characteristics such as screen size, color capabilities, image capabilities, manufacturer, etc.; software characteristics such as operating system vendor and version, list of audio, image and video Multi-purpose Internet Mail Extensions (MIME) media types, etc.; application/user preferences such as browser manufacturer and version, markup languages and versions supported, scripting languages supported, etc.; WAP characteristics such as Wireless Markup Language (WML) script libraries, WAP version, WML deck size, etc.; and network characteristics such as latency and reliability.

In the framework for adaptation according to the present invention, the SIP proxies, e.g., S-CSCF of the 3GPP architecture, determines the need for transcoding based on the media capabilities of the end terminals. If, for example, the first end terminal requires video data conforming to the H.263 standard, while the second end terminal requires an MPEG-4 video stream, then an adaptation server must be invoked to perform the required transcoding functions necessary to allow the first and second end terminals to exchange video data. Accordingly, transport parameters within the SDP description, such as IP address and port number, are modified by the adaptation server to allow redirection of the video streams from the respective end terminals to the adaptation server for the required transcoding.

Alternately, the end terminals may be capable of exchanging a number of different multimedia formats that overlap with the various transcoding capabilities of the adaptation server. In such an instance, the adaptation decision may be implemented by the adaptation server itself, such that the multimedia formats that are directed for use by the end terminals and the corresponding transcoding function performed by the adaptation server, yields the best quality multimedia transfer.

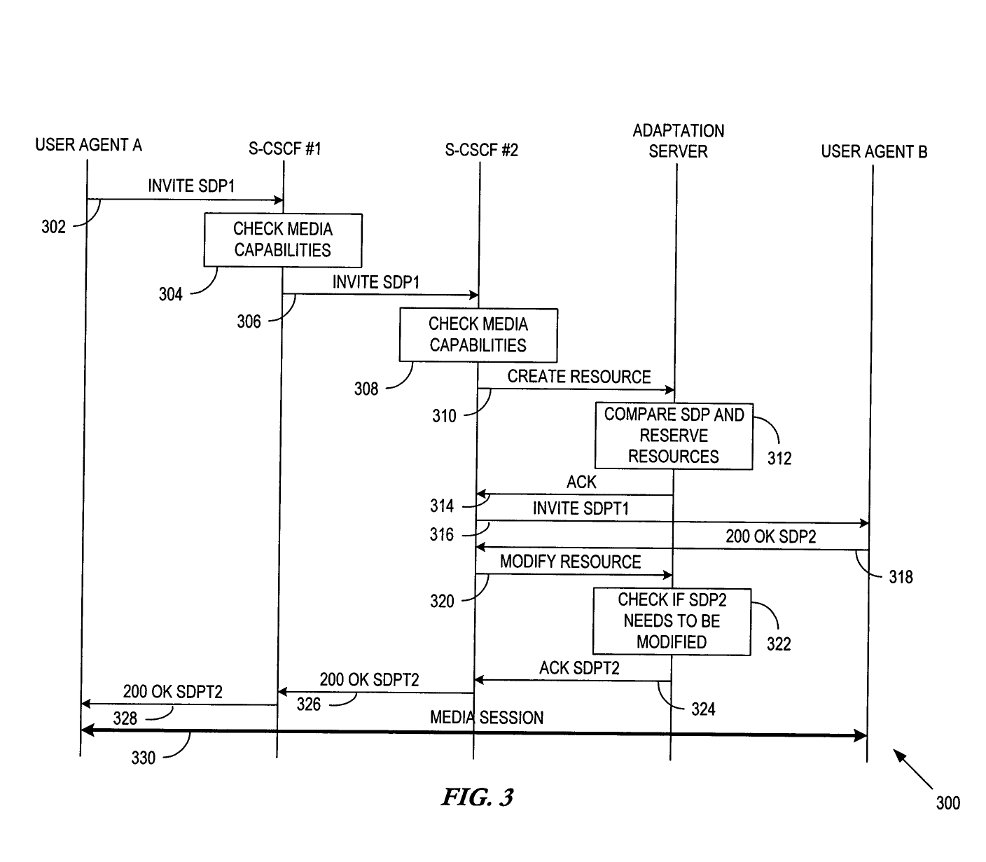

In a first embodiment according to the present invention, a terminating S-CSCF is used for the adaptation decision, e.g., determining the need for transcoding of the video streams based upon the video codec capabilities of the participating user agents. Message flow 300 of FIG. 3 illustrates an exemplary message exchange implemented by an adaptation framework within, for example, the 3GPP IMS architecture.

In message 302, user agent A, e.g., mobile terminal 202 of FIG. 2, transmits a SIP INVITE message to S-CSCF #1. S-CSCF #1 checks the media capabilities of user agent A as defined by the SDP definition for user agent A, i.e., SDP1, in step 304. The check consists of validating that the media capabilities described by SDP1 are compatible with the local network policies. The INVITE message with SDP1 is proxied to S-CSCF #2, which is the home proxy for user agent B, in message 306. S-CSCF #2 then checks the media capabilities of user agent A as defined by SDP1 and compares the session definition with the media capabilities of user agent B as in step 308. S-CSCF #2 has prior knowledge of the media capabilities of user agent B as obtained through the use of, for example: a registrar or a profile server; SDP descriptions obtained from a default SDP session in the registration or profile server; SDP descriptions obtained from a response to an OPTIONS request; or the UAProf specification as discussed above.

S-CSCF #2 determines whether adaptation is required based upon the comparison of SDP1 with the capability definitions for user agent B, e.g., SDP2. S-CSCF #2 determines that there is an incompatibility between, for example, the video codec utilized by user agent A and the video codec utilized by user agent B. As such, message 310 is transmitted by S-CSCF #2 to a serving transcoder, as implemented for example by service capability servers 106 of FIG. 1, where message 310 contains the SDP definitions for both user agent A and B.

The adaptation server then compares the SDP definitions for user agent A and user agent B, determines the resources that are required to translate the media streams between user agent A and B, and then reserves those resources to support the media session in step 312. The adaptation server then modifies the SDP1 definition for user agent A to form the modified SDP definition, SDPT1, if required. Similarly, the adaptation server modifies the SDP2 definition for user agent B to form the modified SDP definition, SDPT2, if required. The adaptation server then transmits the modified SDP definitions, SDPT1 and SDPT2, to S-CSCF #2 within acknowledgment message 314, where the modified SDP definitions provide updated IP address, port number, media type, codec, and attribute information to support the media session.

S-CSCF #2 then transmits an INVITE message containing the modified session definition for user agent A, SDPT1, to user agent B in message 316. The SDPT1 session definition contains, for example, the appropriate IP address and port number of the adaptation server to be used by user agent B when transmitting its media stream during the media session. SDPT1 also contains a compatible codec definition supported by user agent B. User agent B then responds with 200 OK message 318 that contains its SDP session definition, SDP2.

S-CSCF #2 sends the modified session definition SDPT1 and the newly received session definition SDP2 to the adaptation server in message 320 so that the resource definition of SDP2 may be modified, as required, to correlate with the resources that were reserved in step 312. The adaptation server then compares SDPT1 with SDP2 in step 322 to determine whether or not SDP2 is required to be modified. Acknowledgment message 324 containing the modified SDP2 session definition, SDPT2, is then transmitted to S-CSCF #2, which is proxied to S-CSCF #1 in 200 OK message 326. S-CSCF #1 then proxies 200 OK message 328 containing the modified session definition SDPT2 to user agent A, where the SDPT2 session definition contains the appropriate IP address and port number of the adaptation server to be used by user agent A when transmitting its media stream during the media session. SDPT2 also contains a compatible codec definition supported by user agent A. Once the appropriate acknowledgment messages (not shown) have been exchanged, media session 330 may commence.

In an alternate embodiment according to the present invention, the adaptation server may advise S-CSCF #2 as to whether transcoding will be necessary for the pending media session. In such an embodiment, acknowledgment message 314 may contain either a confirmation that transcoding is required, or an advisory that transcoding is not required. In case of an advisory, further communication with adaptation server is not required and media session 330 may commence without intervention by the adaptation server.

Media session diagram 400 illustrates an exemplary session description flow in accordance with the present invention that illustrates the SDP description modifications corresponding to message flow 300 of FIG. 3. A portion of the session description for mobile terminal 402 is illustrated by the SDP1 description contained within message 412 in which the connection data, c=<network type><address type><connection address>, and the media description, m=<media><port><transport><fmt list>, are listed. The connection data, C=IN IP4 0.0.0.1, indicates that: the Internet network type is specified, for example, by the characters, “IN”; IP version 4 is the address type specified by the characters “IP4”; and an IP address of “0.0.0.1” is listed as the connection address for user agent A. The media description M=video 49232 RTP/AVP XX, indicates that: video media is to be used as specified by the characters “video”; a port number of “49232” is specified as the port number corresponding to user agent A; the Real-time Transport Protocol using the Audio/Video Profile (RTP/AVP) is to be utilized; and a format number specified by the characters “XX” indicating that the video format supported by mobile terminal 402 is, for example, H.263. It should be noted that the SDP1 description contained within message 412 comprises only a portion of the session description SDP1 of message 302 and is presented in its abbreviated form for illustration purposes only.

S-CSCF #1 404 then checks the media capabilities described by SDP1 of message 412 and since the network policy enforced by S-CSCF #1 404 allows video stream media sessions, SDP1 is forwarded onto S-CSCF #2 408 via message 414, corresponding to message 306 of message flow 300. Message 416, corresponding to message 310 of message flow 300, contains the SDP1 description received in message 414, but also contains the previously registered SDP description, e.g., SDPR2, corresponding to user agent B 410. As discussed above, S-CSCF #2 408 has prior knowledge of the media capabilities of user agent B 410 as obtained through the use of, for example: a registrar or a profile server; SDP descriptions obtained from a default SDP session in the registration or profile server; SDP descriptions obtained from a response to an OPTIONS request; or the UAProf specification. The previously registered SDPR2 information provides default information about user agent B 410 such as its IP address, e.g., 0.0.0.2, its default port number, e.g., 0000, and its video capability, e.g., YY, which may correspond to an MPEG-4 video format, for example.

Adaptation server 406 then performs the SDP comparison step as illustrated by step 312 of message flow 300, whereby adaptation server 406 compares SDP descriptions SDP1 and SDPR2, determines the required adaptation and reserves the necessary resources to implement the required adaptation. In particular, SDPT1 of message 418 defines in part the resources reserved by adaptation server 406 as a result of the comparison of SDP descriptions SDP1 and SDPR2 and the determination that the video media exchanged by user agent A 402 and user agent B 410 requires adaptation.

SDPT1, for example, defines that port number 49262 at IP address 0.0.0.3 is to be used by user agent B 410 when sending video media to user agent A 402 instead of port number 49232 at IP address 0.0.0.1 as originally defined by SDP1. This port number and IP address change is required since all video media received by user agent A 402 must be adapted by adaptation server 406 subsequent to transmission by user agent B 410. In addition, the video format originally disclosed by user agent A 402 in SDP1 is changed from XX to YY so that user agent B 410 assumes that video compatibility exists with user agent A 402. The modified SDP definition, SDPT1, is then transmitted to user agent B 410 in message 420, which corresponds to message 316 of message flow 300.

In response, user agent B 410 transmits its SDP description, e.g., SDP2, via message 422, corresponding to 2000K message 318 of message flow 300. The SDP2 description defines, for example, that user agent B 410 is assigned port number 49292 at IP address 0.0.0.2, whereby video capability YY is required. Video capability YY may represent, for example, an MPEG-4 video format capability that is supported by user agent B 410. S-CSCF #2 408 then transmits SDP description SDP2 to adaptation server 406 via message 424, which corresponds to message 320 of message flow 300, in order for adaptation server 406 to determine the need for modification of SDP2 as defined in message 422.

Since video media transmitted to user agent B 410 must first be adapted by adaptation server 406, SDP2 is modified by adaptation server 406 to reflect the port number, e.g., 49264, and IP address, e.g., 0.0.0.3, of adaptation server 406 that is to be used by user agent A 402 when transmitting video media. Thus, SDP definition SDP2 is changed by adaptation server 406 to SDP definition SDPT2 and forwarded to S-CSCF #2 408 via message 426, corresponding to message 324 of message flow 300. SDPT2 is then forwarded onto user agent A 402 via message 428, which corresponds to messages 326 and 328 of message flow 300.

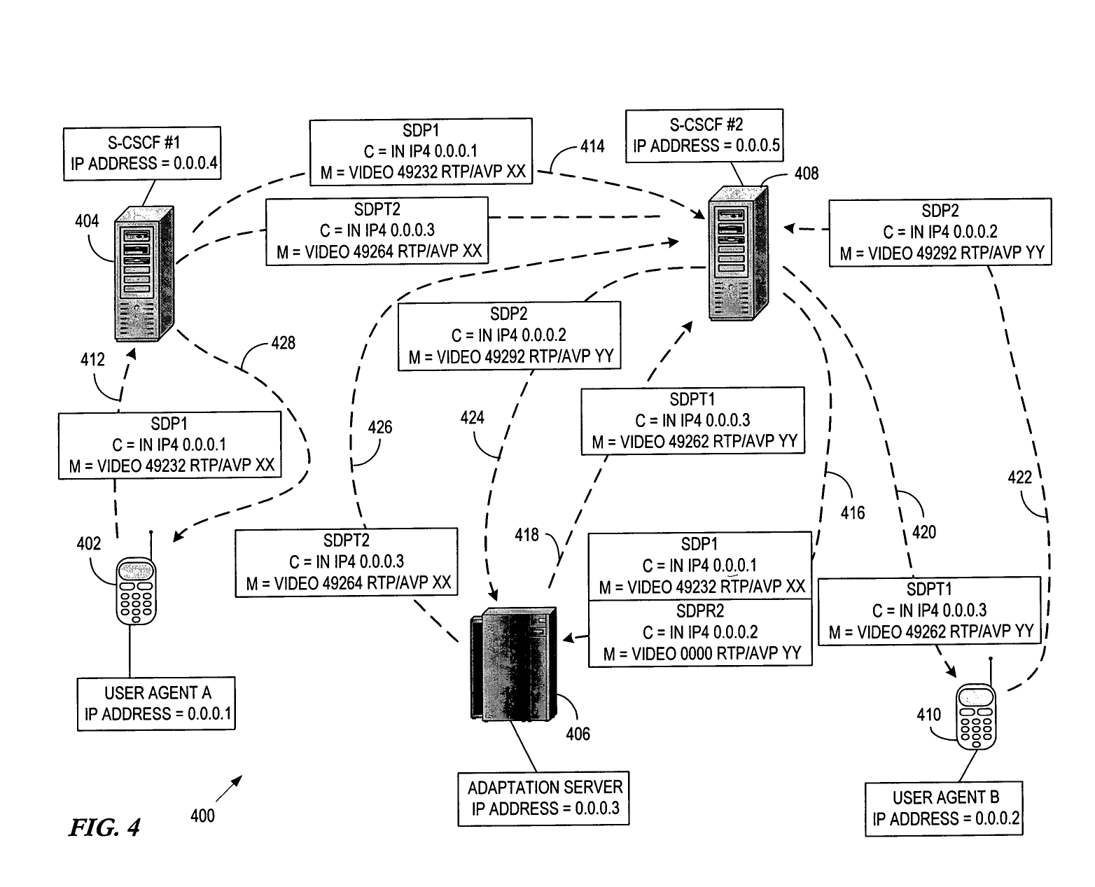

The end result of the SDP definition modifications exemplified by FIG. 4 is that media session 330 of message flow 300 includes the adaptation services offered by adaptation server 406. In particular, video media transmitted by user agent A 402 to user agent B 410, first traverses adaptation server 406 via port 49264 at IP address 0.0.0.3 so that the video media may undergo XX->YY video adaptation. The XX->YY adapted video is then received by user agent B, having IP address 0.0.0.2, at port number 49292 from adaptation server 406, with IP address 0.0.0.3. Conversely, video media transmitted by user agent B 410 to user agent A 402 must first traverse port number 49262 at IP address 0.0.0.3 of adaptation server 406 in order for the YY->XX video adaptation to take place. User agent A 402 then receives the YY->XX adapted video at port 49232 from IP address 0.0.0.3 corresponding to adaptation server 406.

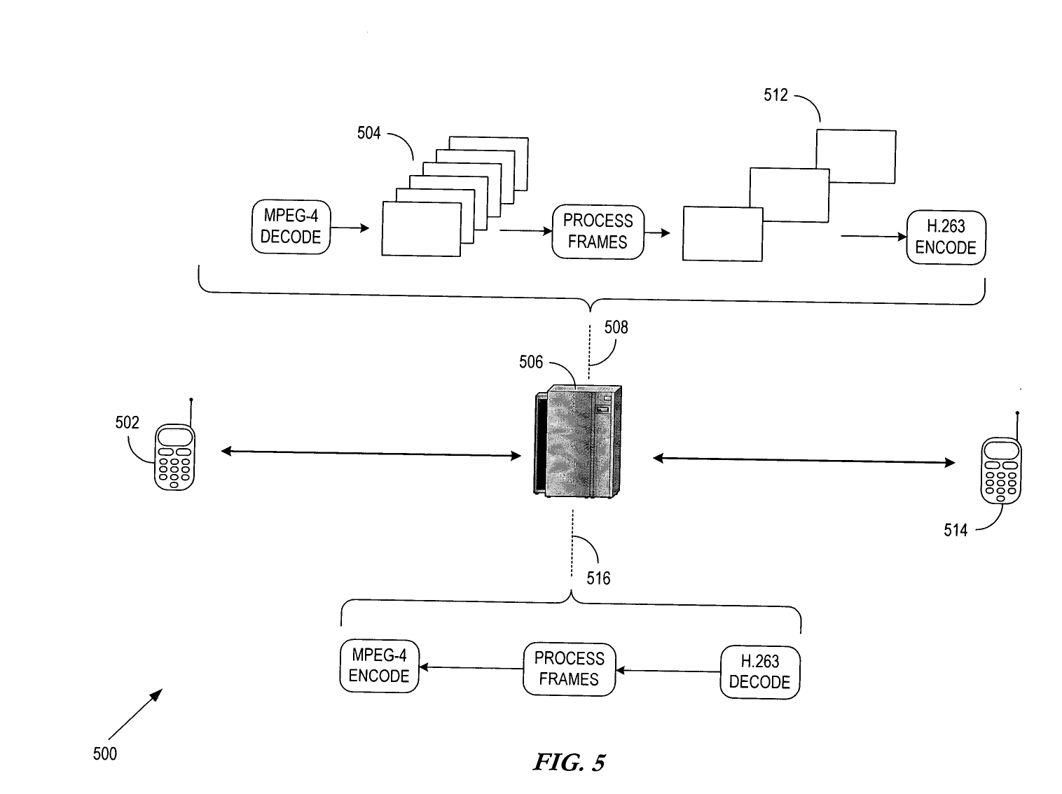

FIG. 5 illustrates exemplary transcoding process 500 performed by adaptation server 506 in accordance with the present invention enabling interoperability between mobile terminal 502 and mobile terminal 514. Mobile terminals 502 and 514 may have different media types, codecs or attributes, which otherwise would prevent communication between the two devices. Due to the session description modifications exemplified in FIG. 4 and the media transcoding process as exemplified in FIG. 5, mobile terminals 502 and 514 may establish a multimedia session despite having media incompatibilities in accordance with the present invention.

In particular, mobile terminal 502 may, for example, be equipped with a high quality, low data rate video capability such as an MPEG-4 video encoder over a low bandwidth network, while mobile terminal 514 may only be equipped with high bit rate video encoding capability, such as defined by the H.263 specification. Accordingly, adaptation server 506 is required to perform full duplex, video transcoding of the MPEG-4/H.263 media streams, as illustrated by transcoding paths 508 and 516, that are exchanged by mobile terminals 502 and 514 during, for example, media session 330 of FIG. 3.

Media streams received from mobile terminal 502 by adaptation server 506 are first decoded into decompressed video frames 504, where they are then converted to form video sequence 512. The video sequences are then re-encoded into a higher or equal rate H.263 bit stream and subsequently forwarded onto mobile terminal 514 as illustrated by processing path 508. Similarly, media streams received from mobile terminal 514 are transcoded into MPEG-4 encoded video streams of lower bit rate and subsequently forwarded onto mobile terminal 502 as illustrated by processing path 516. It should be noted that many transcoding techniques may be used and the transcoding process described in FIG. 5 is merely illustrative of one such technique.

Due to processing paths 508 and 516 as provided by adaptation server 506, mobile terminals 502 and 514 may conduct media sessions irrespective of their own media capabilities and without regard for the media capabilities of other mobile terminals. In addition, mobile terminals 502 and 514 are provided the opportunity to obtain the highest quality media transfer based upon their media capabilities. For example, if SDP description 412 of FIG. 4 indicated that mobile terminal 402 was capable of the following video formats: “XX”, “YY”, and “ZZ”, where “XX” represents the highest quality format; and SDP description 418 indicated that mobile terminal 410 was capable of the following video formats: “YY” and “ZZ”, then adaptation server 406 automatically selects the common video format having the highest quality, i.e., “YY”, thus eliminating the possibility of using the lowest quality video format, i.e., “ZZ”, during the media session.

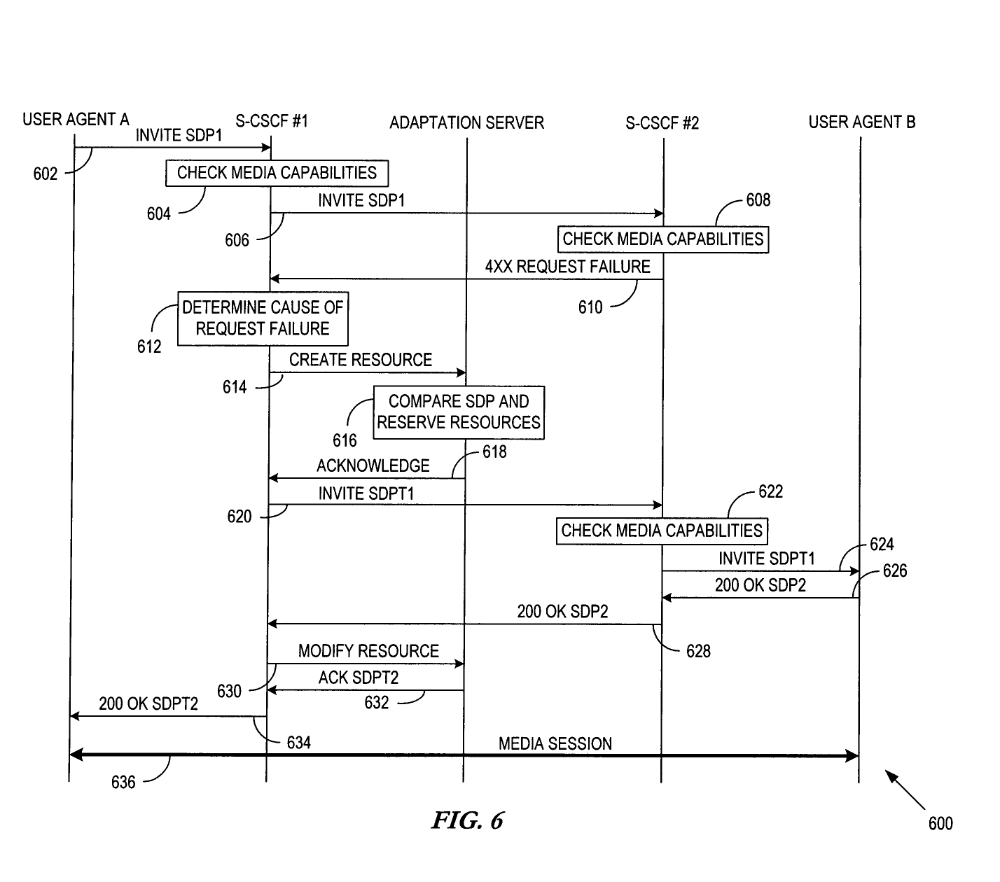

In an alternate embodiment according to the present invention, an originating S-CSCF is used for the adaptation decision, e.g., determining the need for transcoding of the video streams based upon the video codec capabilities of the participating user agents. Message flow 600 of FIG. 6 illustrates an exemplary message exchange implemented by an adaptation framework within, for example, the 3GPP IMS architecture.

In message 602, user agent A, e.g., mobile terminal 202 of FIG. 2, transmits a SIP INVITE message to S-CSCF #1. S-CSCF #1 checks the media capabilities of user agent A as defined by the SDP definition for user agent A, i.e., SDP1, in step 604. The check consists of validating that the media capabilities defined by SDP1 are compatible with the local network policies. The INVITE message with SDP1 is proxied to S-CSCF #2, which is the home proxy for user agent B, in message 606. S-CSCF #2 then checks the media capabilities of user agent A as defined by SDP1 and compares the session definition with the media capabilities of user agent B. S-CSCF #2 has prior knowledge of the media capabilities of user agent B as obtained through, for example: a registrar or a profile server; SDP descriptions obtained from a default SDP session in the registration or profile server; SDP descriptions obtained from a response to an OPTIONS request; or the UAProf specification as discussed above.

S-CSCF #2 compares the SDP1 description with the capability definitions for user agent B, e.g., SDP2. S-CSCF #2 determines that there is an incompatibility between, for example, the video codec utilized by user agent A and the video codec utilized by user agent B. As such, message 610, e.g., 4XX Request Failure, is transmitted by S-CSCF #2 to S-CSCF #1, whereby S-CSCF #1 determines the cause of the request failure in step 612. Realizing the incompatibilities between SDP1 and SDP2, S-CSCF #1 sends SDP1 and SDP2 to a serving transcoder, as implemented for example by service capability servers 106 of FIG. 1, in step 614.

The adaptation server then compares the SDP definitions for user agent A and user agent B, determines the resources that are required to translate the media streams between user agent A and B, and then reserves those resources to support the media session in step 616. The adaptation server then modifies the SDP1 definition for user agent A to form the modified SDP definition, SDPT 1, if required. The adaptation server then transmits the modified SDP definition, SDPT1, to S-CSCF #1 within acknowledgment message 618, where the modified SDP definition provides updated IP address, port number, media type, codec, and attribute information associated with the adaptation server to support the media session.

S-CSCF #1 then transmits an INVITE message containing the modified session definition for user agent A, SDPT1, to S-CSCF #2 in message 620. The SDPT1 session definition contains, for example, the appropriate IP address and port number of the adaptation server to be used by user agent B when transmitting its media stream during the media session. SDPT1 also contains a compatible codec definition supported by user agent B. S-CSCF #2 then checks the media capabilities between SDPT1 and SDP2 in step 622 and determines that a compatibility match now exists between the media capabilities of user agent A and B. S-CSCF #2 then proxies the INVITE message to user agent B in message 624, to which user agent B responds with 200 OK message 626 that contains its SDP session definition, SDP2. The 200 OK message is then proxied to S-CSCF #1 in message 628.

S-CSCF #1 sends the modified session definition SDPT1 and the newly received session definition SDP2 to the adaptation server in message 630 so that the resource definition of SDP2 may be modified, as required, to correlate with the resources that were reserved in step 616. The adaptation server then compares SDPT1 with SDP2 to determine whether or not SDP2 is required to be modified. Acknowledgment message 632 containing the modified SDP2 session definition, SDPT2, is then transmitted to S-CSCF #1, which is proxied to user agent A in 200 OK message 634. Once the appropriate acknowledgment messages (not shown) have been exchanged, media session 636 may commence.

It should be noted that S-CSCF #2 may represent a legacy network element that may only provide network policy adherence in steps 608 and 622. In the case of step 608, for example, S-CSCF #2 verifies that SDP1 adheres to network policy and then may forward the INVITE message directly on to user agent B. In the case of incompatible media capability definitions, user agent B would then return the 4XX REQUEST FAILURE message, instead of S-CSCF #2. Similarly, legacy S-CSCF #2 may also provide network policy adherence in step 622.

In an alternate embodiment according to the principles of the present invention, neither the originating S-CSCF nor the terminating S-CSCF determines the necessity for adaptation. Rather, the adaptation server makes the decision based upon the SDP definitions provided by the respective S-CSCFs. In particular, step 312 of FIG. 3 may represent the decision performed by adaptation server 212 of FIG. 2., whereby the necessity for adaptation is determined and subsequently expressed within acknowledgment message 314. If adaptation is needed, then multimedia flows are necessarily redirected to the adaptation server by each of the serving S-CSCFs for subsequent adaptation. If, on the other hand, adaptation is not required, then multimedia exchange may proceed directly between the end points without the need for redirection to the adaptation server.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create an adaptation system and method in accordance with the present invention.

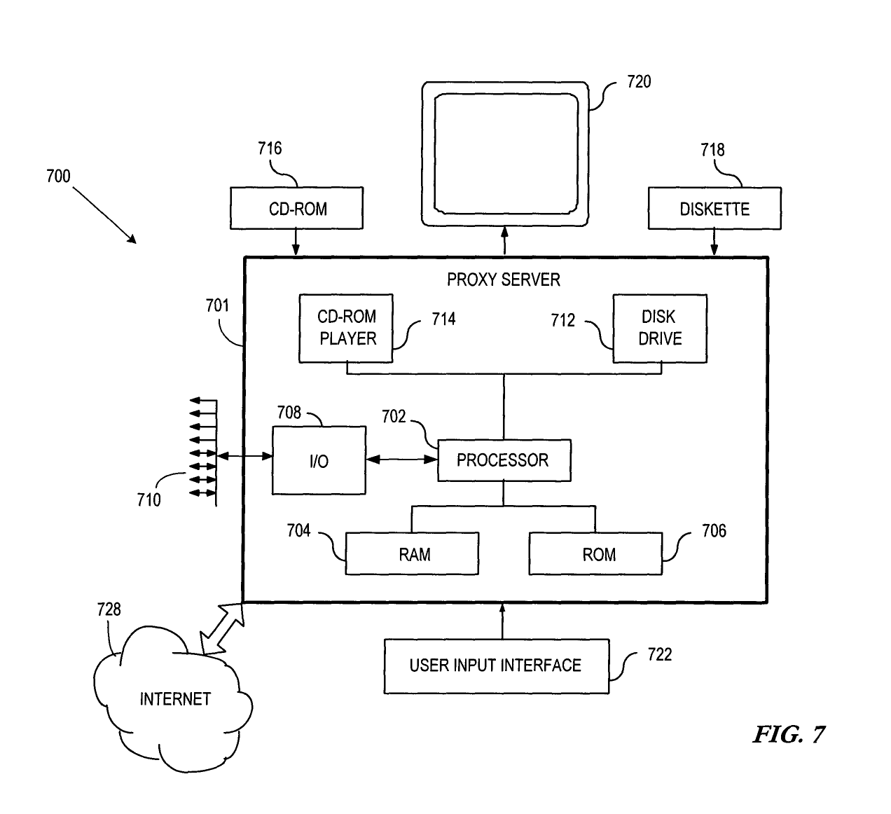

The network servers or other systems for providing media adaptation functions in connection with the present invention may be any type of computing device capable of processing and communicating digital information. The network servers utilize computing systems to control and manage the messaging activity. An example of a representative computing system capable of carrying out operations in accordance with the invention is illustrated in FIG. 7. Hardware, firmware, software or a combination thereof may be used to perform the various proxy functions and operations described herein. The computing structure 700 of FIG. 7 is an example computing structure that can be used in connection with such an adaptation system.

The example computing arrangement 700 suitable for performing the adaptation activity in accordance with the present invention includes proxy server 701, which includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, a SIP message such as that exemplified by message 306 of FIG. 3 may be received by proxy server 701 to enable an adaptation decision to be made by proxy server 701. External data storage devices, such as profile servers, may be coupled to I/O circuitry 708 to facilitate adaptation decision functions according to the present invention. Alternatively, such databases may be locally stored in the storage/memory of the proxy server 701, or otherwise accessible via a local network or networks having a more extensive reach such as the Internet 728. The processor 702 carries out a variety of functions as is known in the art, as dictated by software and/or firmware instructions.

Proxy server 701 may also include one or more data storage devices, including hard and floppy disk drives 712, CD-ROM drives 714, and other hardware capable of reading and/or storing information such as DVD, etc. In one embodiment, software for carrying out the adaptation decisions in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to proxy server 701 via data signals, such as being downloaded electronically via a network, such as the Internet. Proxy server 701 is coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

Proxy server 701 may be coupled to other computing devices, such as the landline and/or wireless terminals via a network. The server may be part of a larger network configuration as in a global area network (GAN) such as the Internet 728, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method for establishing a media session between terminals having incompatible media characteristics, comprising:
transmitting a first media session description associated with a first terminal to a network element;
comparing the first media session description to a second media session description associated with a second terminal;
determining an incompatibility between the first and second media session descriptions; and
invoking an adaptation server by the network element to adapt media flow between the first and second terminals, wherein the adaptation server alters the first media session description to meet capabilities of the second terminal and alters the second media session description to meet capabilities of the first terminal.

2. The method according to claim 1, wherein the first media session description is propagated by a Third Generation Partnership Project (3GPP) Internet Protocol Multimedia Subsystem (IMS) network.

3. The method according to claim 1, wherein determining an incompatibility comprises determining media capabilities identified by the first and second media session descriptions.

4. The method according to claim 3, wherein the media capabilities include codec, resolution, frame rate, and bit rate definitions.

5. The method according to claim 4, wherein the incompatibility is determined by a serving proxy to the first terminal.

6. The method according to claim 5, wherein the serving proxy to the first terminal invokes the adaptation server.

7. The method according to claim 4, wherein the incompatibility is determined by the adaptation server.

8. The method according to claim 4, wherein the incompatibility is determined by a serving proxy to the second terminal.

9. The method according to claim 8, wherein the serving proxy to the second terminal invokes the adaptation server.

10. The method according to claim 1, wherein the alteration of the first media description includes:
changing media parameters to meet media capabilities associated with the second terminal; and
changing transport parameters to match an IP address and port number associated with the adaptation server.

11. The method according to claim 1, wherein the alteration of the second media description includes:
changing media parameters to meet media capabilities associated with the first terminal; and
changing transport parameters to match an IP address and port number associated with the adaptation server.

12. An adaptation system for peer-to-peer multimedia sessions, comprising:
a network proxy coupled to receive media session definitions indicative of first and second terminal capabilities; and
an adaptation server coupled to receive the media session definitions from the network proxy and coupled to provide adaptation of media streams and associated media session definitions between the first and second terminals, wherein the media streams are redirected to the adaptation server in response to an incompatibility discovery between the capabilities of the first and second terminals.

13. The adaptation system of claim 12, wherein the network proxy receives the media session definition indicative of the first terminal capability via a Session Initiation Protocol (SIP) message.

14. The adaptation system of claim 13, wherein the network proxy receives the media session definition indicative of the second terminal capability via a SIP proxy.

15. The adaptation system of claim 13, wherein the network proxy receives the media session definition indicative of the second terminal capability via a registrar server.

16. The adaptation system of claim 13, wherein the network proxy receives the default media session definition indicative of the second terminal capability via a registration message from the second terminal.

17. The adaptation system of claim 13, wherein the network proxy receives the default media session definition indicative of the second terminal capability via an options query.

18. The adaptation system of claim 12, wherein the incompatibility discovery is made by the network proxy.

19. The adaptation system of claim 18, wherein the network proxy invokes the adaptation server to change the media session definition of the first terminal to match media capabilities of the second terminal and to change the media session definition of the second terminal to match media capabilities of the first terminal.

20. The adaptation system of claim 19, wherein the network proxy invokes the adaptation server to change the media session definition of the first and second terminals to match transport information and adaptation capabilities associated with the adaptation server.

21. The adaptation system of claim 20, wherein the transport information includes IP address and port number.

22. The adaptation system of claim 12, wherein the incompatibility discovery is made by the adaptation server.

23. A proxy within a network used to facilitate an adaptation decision, comprising:
means for receiving a capability description associated with a first terminal;
means for receiving a capability description associated with a second terminal;
means for comparing the capability descriptions of the first and second terminals;
means for determining an incompatibility between the first and second terminals;
means for transmitting the capability descriptions to an adaptation server for alteration by the adaptation server; and
means for redirecting media streams to the adaptation server to adapt the media streams in response to the incompatibility between the first and second terminals.

24. A computer-readable medium having instructions stored thereon which are executable by a proxy for facilitating media stream adaptation by performing steps comprising:
receiving a capability description associated with a first terminal;
receiving a capability description associated with a second terminal;
comparing the capability descriptions of the first and second terminals to determine an incompatibility between them;
transmitting the capability descriptions to an adaptation server for modification; and
redirecting the media stream to the adaptation server in response to the modified capability descriptions.

25. The computer-readable medium according to claim 24, wherein the step of comparing the capability descriptions comprises comparing an audio-video format variable of a media description line of a Session Description Protocol (SDP) description for both terminals.
